(19) United States
(12) Patent Application Publication
(10) Pub. No.: US 2022/0038435 A1
(43) Pub. Date: Feb. 3, 2022

(54) METHOD FOR SECURE TRANSACTIONS AMONG E-COMMERCE VENDORS

(71) Applicant: CHARLES LAP SAN CHAN, Hong Kong Island (HK)

(72) Inventor: CHARLES LAP SAN CHAN, Hong Kong Island (HK)

(21) Appl. No.: 17/391,005

(22) Filed: Aug. 1, 2021

(30) Foreign Application Priority Data
Aug. 3, 2020 (TW) 109126170

(51) Int. Cl. H04L 29/06; G06Q 30/06; G06Q 30/02; G06Q 50/00

(52) U.S. Cl. CPC H04L 63/0421; G06Q 30/0601; G06Q 30/0635; G06Q 50/01; G06Q 30/0283

(57) ABSTRACT

The present invention proposes a method for secure transactions among multiple e-commerce vendors, so that each e-commerce vendor does not need to disclose their member information to other e-commerce vendors in the process of trading each other's products, and each e-commerce vendor can still lead the right to determine the price of the products per se, avoiding the price war. At the same time, the method of the present invention also provides a monitoring mechanism for the transaction process to improve the degree of mutual trust between e-commerce vendors, and after the completion of the product transaction, the e-commerce vendors can interactively provide after-sales customer services. The method for secure transactions of the present invention guarantees the security of member data, cash flow, logistics, product, and the like.

### TECHNICAL FIELD

The present invention relates to a method for secure transactions between multiple e-commerce vendors. Specifically, this invention indicates a method which enables secure transactions between multiple e-commerce vendors without revealing their customer's membership information to other e-commerce vendors.

### BACKGROUND OF RELATED ARTS

In light of everyone in modern society has a smart phone that can be connected to the Internet, shopping on the Internet has become a part of daily lives. Consumers often have to search or browse through different e-commerce platforms in order to buy different products, or have to consider prices provided by different e-commerce platforms in order to purchase a certain product.

In order to satisfy the needs of online shopping consumers and seize the huge business opportunities accompanied, whether it is a merchant having a business with a physical store, vendors that produce physical products or services, or an office worker who wants to run a sideline to raise their salaries are committed to building e-commerce platforms on the Internet therefore to achieve e-commerce effects.

However, in order to continue to attract consumers to register as members and purchase goods on their own e-commerce platform, e-commerce vendors on each e-commerce platform are indulged in looking for the latest, hottest, or most unique new products. When new products are put on the internet, those members are willing to revisit more frequently, but doing so often causes a burden such as stress on e-commerce vendors. In addition, since members who purchase on e-commerce platforms are important assets of e-commerce companies. To avoid members from being attracted by other e-commerce platforms and thus leaving the original e-commerce platform, the mutual recommendation and communication between e-commerce platforms are also important yet not easy to be implemented. Before cooperating with other e-commerce platforms, e-commerce vendors who operate e-commerce platforms also need to spend a lot of effort to verify whether the product quality, financial status, and business integrity of other e-commerce platforms are reliable enough.

Therefore, how to provide a secure transaction method between multiple e-commerce vendors, which can not only facilitate the e-commerce vendors to launch new products on the shelves to promote the consumption of the existing members, but also promote their products to other e-commerce platform members to purchase. There is no requirement to disclose your membership information to other e-commerce companies, and there is no need to worry about whether the transaction process is deceived by other e-commerce companies that are cooperated with, which may result in losses. The abovementioned has become the active research area for those skilled in the art.

### SUMMARY

The main purpose of the present invention is to provide a secure transaction method between multiple e-commerce vendors, so that each e-commerce vendor does not need to disclose their member information to other e-commerce vendors in the process of trading each other's products.

Another object of the present invention is to provide a method for secure transactions between multiple e-commerce vendors, each of which can still lead the right to put prices on their own products, and simultaneously avoid price-cutting competition.

Still another object of the present invention is to provide a method for secure transactions between multiple e-commerce vendors, to provide a monitoring mechanism for the transaction process to improve the mutual trust between e-commerce vendors, and to be able to provide after-sales customer service between e-commerce vendors after the product transactions are completed.

In order to achieve the abovementioned goals of the present invention, the present invention provides a method for secure transactions among e-commerce vendors allowing each e-commerce vendor to trade products with one another without disclosing member information, which comprises the following steps:
(A) Provide a first e-commerce platform, a second e-commerce platform, a transaction management end platform. The transaction management end platform is connected to the first e-commerce platform and the second e-commerce platform respectively.
(B) Set a first e-commerce product information and a first e-commerce platform information in the first e-commerce platform and set a second e-commerce product information and a second e-commerce platform information in the second e-commerce platform.
(C) Set a first product transceiver module in the first e-commerce platform, a second product transceiver module in the second e-commerce platform, and a management end product transceiver module in the transaction management end platform.
(D) The first product transceiver module sends the first e-commerce product information to the management end product transceiver module. Then, the management end product transceiver module determines whether to send the first e-commerce product information to the second product transceiver module according to a management end product listing rule. The management end product listing rule sets the conditions that the first e-commerce product information must meet. If the conditions are met and the first e-commerce product information is permitted to be sent to the second product transceiver module, then take step (E).
(E) upon the second product transceiver module receiving the first e-commerce product information, launch the first e-commerce product information to concurrently sell products corresponding to the first e-commerce product information and the second e-commerce product information.

The features, advantages, or similar expressions mentioned in this specification do not mean that all the features and advantages that can be exploited by the present invention should be included in any single specific embodiment of the present invention. Rather, it should be understood that the expression of related features and advantages indicate that the specific features, advantages, or characteristics described in conjunction with specific embodiments are included in at least one specific embodiment of the present invention. Therefore, the written description of features, advantages, and similar expressions in this specification may be related to the same specific embodiment, whereas it may not be a necessity.

Embodiments of the invention are illustrated by way of example, and not by way of limitation, in the figures of the accompanying drawings in which like reference numerals refer to similar elements.

### BRIEF DESCRIPTION OF THE DRAWINGS

FIG. 1 illustrates a schematic diagram of an e-commerce platform system of a preferred embodiment of the present invention.

FIG. 2A and FIG. 2B illustrate flowcharts of methods for secure transactions between multiple e-commerce vendors of the preferred embodiments of the present invention.

### DETAILED DESCRIPTION OF THE INVENTION

In order to understand the technical features and practical efficacy of the present invention and to implement it in accordance with the contents of the specification, hereinafter, preferred embodiments of the present invention will be described in detail with reference to the accompanying drawings.

The present invention provides a method for secure transactions between multiple e-commerce vendors, so that each e-commerce vendor not only has no need to disclose their member information to other e-commerce vendors in the process of trading each other's products, but also still be able to lead the right to put prices on their own products and avoid price-cutting competition. Simultaneously, the method in the present invention provides a monitoring mechanism for the transaction process to improve the mutual trust between e-commerce vendors. In the present invention, it is also provided alternately with the after-sales customer service within the e-commerce vendors after the product transactions are completed. By establishing a virtual customer service center, the member who purchases the product can establish a communication link with the e-commerce platform to which the member belongs, so that the member thinks that he/she has made phone calls with the customer service staff of his/her e-commerce platform, but the communication link will be further connected to the customer service staff of the e-commerce platform that actually sold the product to obtain after-sales customer service through the transaction management end platform as the intermediary. The secure transaction method of the present invention guarantees the member data security, cash flow security, logistics security, product security, and the like. The safe transaction method of the present invention can provide e-commerce vendors of e-commerce platforms to conveniently find new products and put them on the shelves for members of their e-commerce platforms to purchase and can also promote their products to members of other e-commerce platforms for purchasing. The e-commerce platform system of the present invention further provides the functions of social media for communication and interaction, so that the e-commerce vendors of the e-commerce platform and their members can establish a closer relationship. More significantly, the application of the secure transaction method of the present invention enables each e-commerce vendor operating an e-commerce platform in this e-commerce platform system to greatly increase the number of product items sold on their own e-commerce platform, and also increase the opportunity of their own products to be purchased by members of other e-commerce platforms. Furthermore, the present invention uses the transaction management end platform as an intermediary to check on the transaction process and can also ensure the security of transactions between e-commerce vendors.

Before further explaining the method of secure transactions between multiple e-commerce vendors disclosed in the present invention, some terms mentioned in this description will be clarified first:
E-commerce vendors: E-commerce vendors have their own products and members, and mainly sell their products to their members through the operation of e-commerce platforms. In common cases, e-commerce vendors are specialized in selling specific categories of products, such as cosmetics or camera products, and the sale of specific categories of products also limits the increase in product items and the growth of the number of members.
E-commerce platform: E-commerce platform provides a platform for e-commerce vendors to manage their members, product transactions, communication, and information transfer.
Member: Members are consumers who have registered their accounts on the e-commerce platform, receive product information on the e-commerce platform, and purchase the products they are interested in.
Transaction management end platform: Transaction management end platform manages the transaction behaviors between e-commerce vendors, and provide member information security, cash flow security, logistics security, and product security.
Transaction management vendor: Transaction management vendor is a vendor operating the transaction management end platform.
Product: Products are the physical goods produced, or the services provided by e-commerce vendors.

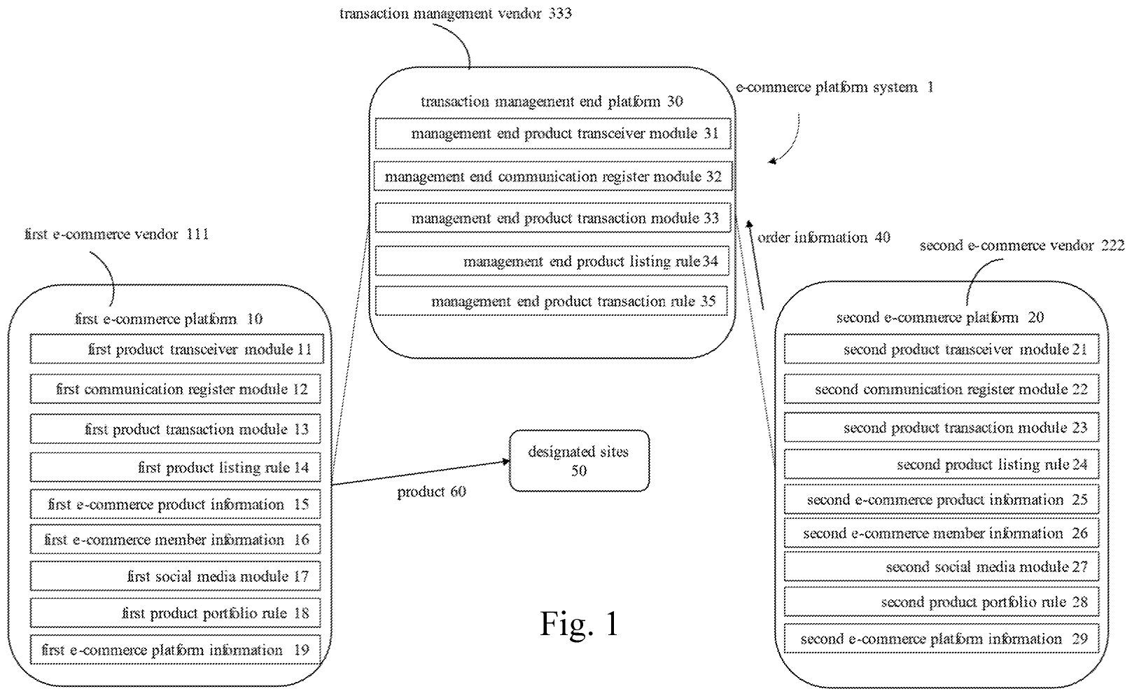

Please refer to FIG. 1, FIG. 1 demonstrates an e-commerce platform system 1 of a preferred embodiment of the present invention. The e-commerce platform system 1 includes first e-commerce platform 10 managed by first e-commerce vendor 111, second e-commerce platform 20 managed by second e-commerce vendor 222, and transaction management end platform 30 managed by transaction management vendor 333. The transaction management end platform 30 is connected to the first e-commerce platform 10 and the second e-commerce platform 20 via wired or wireless networks. The first e-commerce platform 10 is configured with first product transceiver module 11, first communication register module 12, first product transaction module 13, first product listing rule 14, first e-commerce product information 15, first e-commerce member information 16, first social media module 17, first product portfolio rule 18, and first e-commerce platform information 19. The second e-commerce platform 20 is configured with second product transceiver module 21, second communication register module 22, second product transaction module 23, second product listing rule 24, second e-commerce product information 25, second e-commerce member information 26, second social media module 27, second product portfolio rule 28, and second e-commerce platform information 29. The transaction management end platform 30 is configured with management end product transceiver module 31, management end communication register module 32, management end product transaction module 33, management end product listing rule 34, and management end product transaction rule 35.

The first product transceiver module 11 is used to send or receive information to and from the transaction management end platform 30. In addition, the first product transceiver module 11 can also determine whether to send or receive data according to the conditions and rules pre-set by the e-commerce vendor. The first communication register module 12 is used to provide the vendors of the first e-commerce platform 10 for audio or video communication with any user in the e-commerce platform system 1 and has the function of recording the content of the communication, which can achieve the effect of evidence perpetuation. Users in the e-commerce platform system 1 includes: members of the first e-commerce platform 10, vendors of the second e-commerce platform 20, members of the second e-commerce platform 20, and vendors of the transaction management end platform 30. The first product transaction module 13 is used to transact with members of first e-commerce platform 10, including ordering products, sending products, charging fees, etc. The first product transaction module 13 can also be used to transact business with the transaction management end platform 30. For example, when a member of the first e-commerce platform 10 orders a product of the second e-commerce platform 20, the first product transaction module 13 generates an order information and sends the order information to management end product transaction module 33. The said order information does not include the first e-commerce member information 16 to avoid outflow of the first e-commerce member information 16.

The first product listing rule 14 is used to set the conditions; that is, the first e-commerce product information 15, the second e-commerce platform 20 or the second e-commerce product information 25 must deliver on the certain requirements to meet the said conditions. If the conditions are met, the first e-commerce product information 15 is allowed to be sent to the second e-commerce platform 20 via the transaction management end platform 30. The conditions that may be set in the first product listing rule 14 include: an industry classification of the first e-commerce product information 15, a number of products from the first e-commerce product information 15, product prices of the first e-commerce product information 15, an industry classification of the second e-commerce platform 20, a number of members of the second e-commerce platform 20, an industry classification of the second e-commerce product information 25, a number of products of the second e-commerce product information 25, product prices of a second e-commerce product information of 25, or a combination thereof. However, one should note that the present invention is not limited by this embodiment.

The first e-commerce product information 15 contains the products sold on the first e-commerce platform 10 and the related information about the products, such as a digital camera, its related specifications including weight, shutter, aperture as well as its compliance with product regulation or product quality data, industry classification, etc. Alternatively, the first e-commerce product information 15 may comprise a beauty care lotion, its related specifications comprising capacity, ingredients, origin, etc., as well as its compliance with product regulation or product quality information, industry classification, etc. Otherwise, the first e-commerce product information 15 may further comprise a piece of clothing, its related specifications including color, size, gender, etc., and its compliance with product regulation or product quality information, industry classification, etc. The first e-commerce member information 16 includes but is not limited to the information of one or more members, and the information of each member may also include but is not limited to the following items, such as name, gender, phone number, address, account number, password and distribution ratio information, just to name a few. The distribution ratio information is used to encourage members to introduce other members to join the same e-commerce platform for consumption. Then, the e-commerce platform vendor allocates cash or bonus points that can be purchased serving as a commission feedback to the introducer's member according to the shopping amount of the introduced member based on the distribution ratio data (e.g., 3%). As mentioned above, member information is an important asset of every e-commerce vendor, so the first e-commerce member information 16 shall only be stored on the first e-commerce platform 10.

The first social media module 17 is used to form a community between the vendor of the first e-commerce platform 10 and the members of the first e-commerce platform 10, utilizing the multimedia to communicate in the community. Especially as there is any information or information about products requires to be presented, the vendor of the first e-commerce platform 10 provides the information thereon through the first social media module 17 to the members of the first e-commerce platform 10. The first product portfolio rule 18 is used to set conditions. When the conditions are met, one of the first e-commerce product information 15 and one of the second e-commerce product information 25 are combined to form an e-commerce product portfolio, and then this e-commerce product portfolio is going on sale. The conditions of the first product portfolio rule 18 may include but are not limited to: industry classification of the first e-commerce product information 15, number of products from first e-commerce product information 15, product prices of the first e-commerce product information 15, industry classification of the first e-commerce platform 10, number of members of the first e-commerce platform 10, industry classification of the second e-commerce platform 20, number of members from the second e-commerce platform 20, industry classification of the second e-commerce product information 25, the number of products of the second e-commerce product information 25, the product prices of the second e-commerce product information 25, or a combination thereof. The first e-commerce platform information 19 may include yet is not limited to: an industry classification of the first e-commerce platform 10, and a number of members of the first e-commerce platform 10.

The second product transceiver module 21 is used to send or receive information to and from the transaction management end platform 30. In addition, the second product transceiver module 21 can also determine whether to send or receive information according to the conditions and rules pre-set by the e-commerce vendor. The second communication register module 22 is used to provide the vendors of the second e-commerce platform 20 for audio or video communication with any user in the e-commerce platform system 1 and has the function of recording the content of the communication, which can obtain the effect of evidence perpetuation. The users in the e-commerce platform system 1 includes members of the first e-commerce platform 10, vendors of the first e-commerce platform 10, members of the second e-commerce platform 20, and vendors of the transaction management end platform 30. The second product transaction module 23 is used to transact with members of the second e-commerce platform20, comprising ordering products, sending products, charging fees, etc. The second product transaction module 23 can also be used to transacts with the transaction management end platform 30. For example, when a member of the second e-commerce platform 20 orders a product of the first e-commerce platform 10, the second product transaction module 23 generates an order information and sends the order information to the management end product transaction module 33. The said order information does not include the second e-commerce member information 26 to avoid outflow of the second e-commerce member information 26.

The second product listing rule 24 is used to set the conditions; that is, the first e-commerce product information 15, the first e-commerce platform 10 or the second e-commerce product information 25 must deliver on the certain requirements to meet the said conditions. If the conditions are met, the first e-commerce product information 15 is allowed to be sent to the second e-commerce platform 20. The conditions that may be set in the second product listing rule 24 include: an industry classification of the first e-commerce product information 15, a number of products from the first e-commerce product information 15, product prices of the first e-commerce product information 15, an industry classification of the first e-commerce platform 10, a number of members of the first e-commerce platform 10, an industry classification of the second e-commerce product information 25, a number of products of the second e-commerce product information 25, product prices of a second e-commerce product information of 25, or a combination thereof. However, one should note that the present invention is not limited by this embodiment.

The second e-commerce product information 25 contains the products sold on the second e-commerce platform 20 and the related information of the products. Please refer to the preceding description about the first e-commerce product information 15 recited therein which contains many details of the second e-commerce product information 25 not addressed herein. The second e-commerce member information 26 includes but is not limited to the information of one or more members, and the information of each member may also include but is not limited to the following items, such as name, gender, phone number, address, account number, password and distribution ratio information, just to name a few. The details of the second e-commerce member information 26 may be specified by the description in the first e-commerce member information 16 mentioned previously, which will not be repeated here. As mentioned earlier, member information is an important asset of every e-commerce vendor, so the second e-commerce member information 26 shall merely be stored in the second e-commerce platform 20.

The second social media module 27 is used to form a community between the vendor of the second e-commerce platform 20 and the members of the second e-commerce platform 20, utilizing the multimedia to communicate in the community. Especially as there is any information or information about products requires to be presented, the vendor of the second e-commerce platform 20 provides the information thereon through the second social media module 27 to the members of the second e-commerce platform 20. The second product portfolio rule 28 is used to set conditions. When the conditions are met, one of the first e-commerce product information 15 and one of the second e-commerce product information 25 are combined to form an e-commerce product portfolio, and then this e-commerce product portfolio is going on sale. The conditions of the second product portfolio rule 28 may refer to the previous descriptions recited in the first product portfolio rule 18 containing the details not addressed herein. The second e-commerce platform information 29 may include yet is not limited to: an industry classification of the second e-commerce platform 20, and a number of members of the second e-commerce platform 20.

The management end product transceiver module 31 can also be used to send or receive information to and from other e-commerce platforms. In addition, the management end product transceiver module 31 can also determine whether to send or receive information according to the conditions and rules pre-set by the e-commerce vendor. The management end communication register module 32 is used to provide the vendor of the transaction management end platform 30 for audio or video communication with any user in the e-commerce platform system 1 and has the function of recording the content of the communication, which can obtain the effect of evidence perpetuation. Especially, when the vendors of the first e-commerce platform 10 and the vendors of the second e-commerce platform 20 have to communicate and discuss in advance in order to put their products on the shelves, a communication link connecting the first communication register module 12, the management end communication register module 32 and the second communication register module 22 may be established to implement the present invention. When the vendors of the first e-commerce platform 10 communicate with the vendors of the second e-commerce platform 20, the content of the communication between the above two platforms is recorded and stored as evidence by at least the management end communication register module 32. In addition, when the two e-commerce vendors have to interact with each other and provide after-sales customer service within the interaction, they can also communicate through the communication link established by the first communication register module 12, the management end communication register module 32, and the second communication register module 22. The management end communication register module 32 records and stores the preceding communication content between shopping members and e-commerce vendors, saving them as evidence.

The management end product transaction module 33 is used to determine whether an order information 40 from the second product transaction module 23 is allowed to be sent to the first product transaction module 23 via the transaction management end platform 30 according to the conditions set by a management end product transaction rule 35. The conditions that can be set by the management end product transaction rule 35 include but are not limited to: cap amount for order of the first e-commerce platform 10, cap amount for order of the second e-commerce platform 20, or a combination thereof. The management end product listing rule 34 is used to determine whether to allow the first e-commerce product information 15 to be sent to the second product transceiver module 21 via the transaction management end platform 30. The management end product listing rule 34 sets the conditions that the first e-commerce product information 15 must meet. If the conditions are met, the first e-commerce product information 15 is sent to the second product transceiver module 21 via the transaction management end platform 30. The management end product listing rule 34 includes but is not limited to: a product regulation, a product quality information, or a combination thereof.

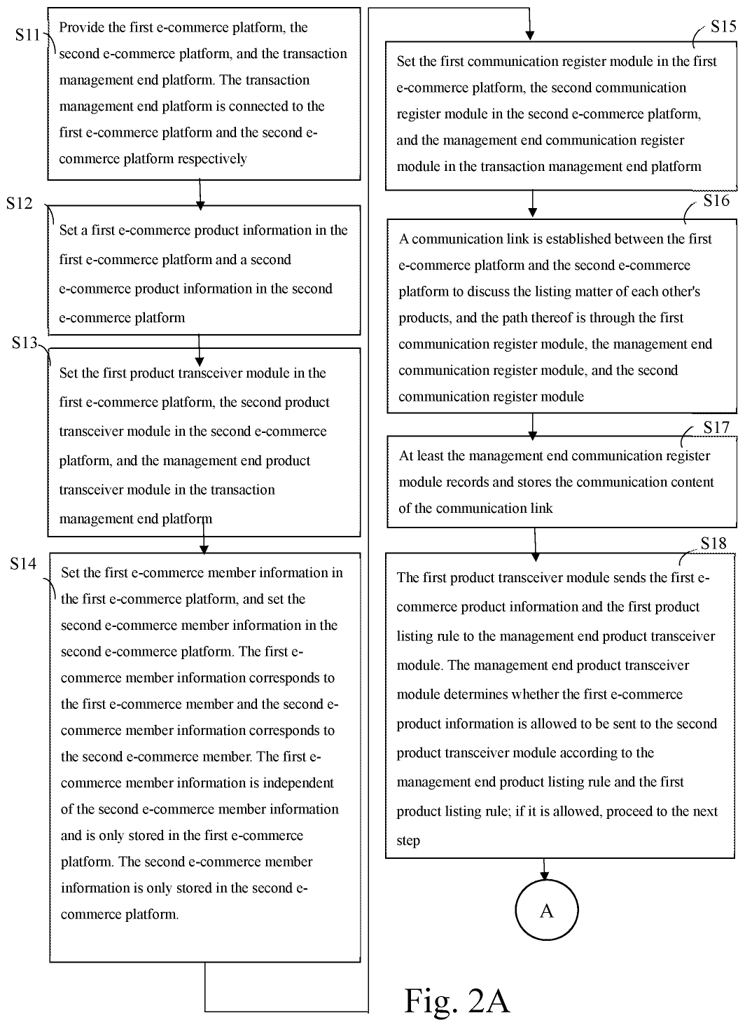

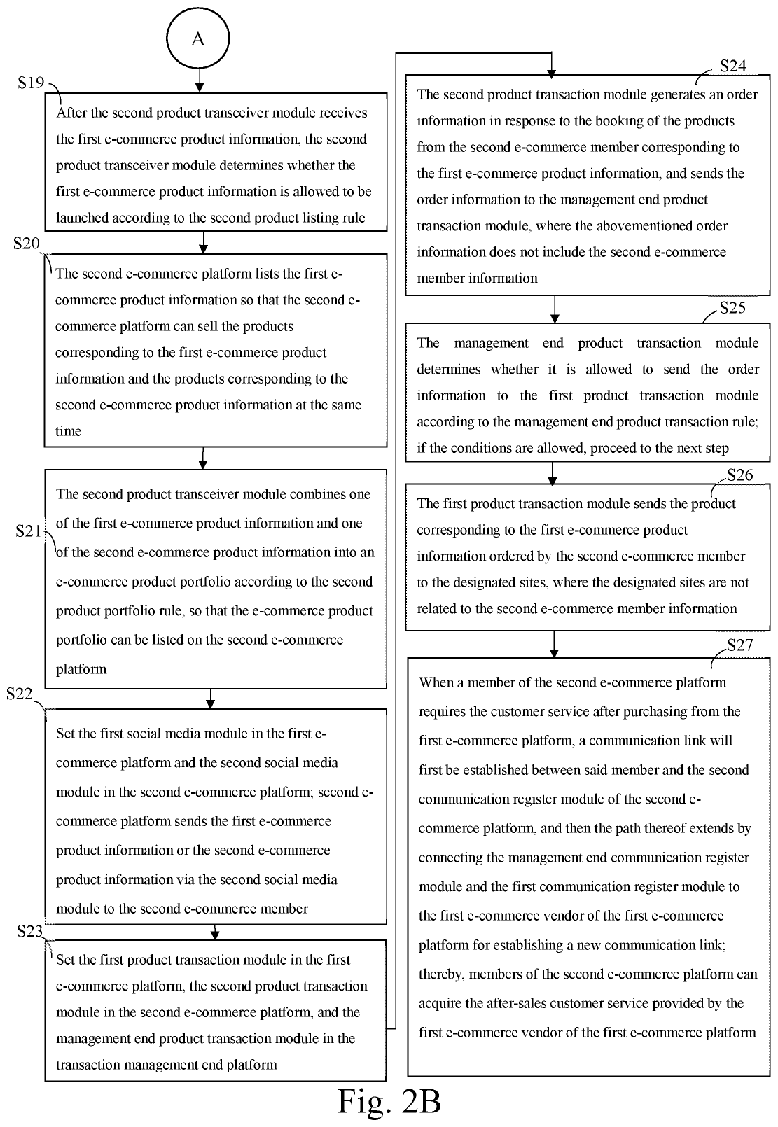

Please refer to FIG. 2A and FIG. 2B, which demonstrates a flowchart of a secure transaction method between multiple e-commerce vendors according to a preferred embodiment of the present invention. In this embodiment, it is shown that when the first e-commerce product information 15 of the first e-commerce platform 10 is to be launched on the second e-commerce platform 20, the members of the second e-commerce platform 20 are provided with the secure transaction method for each purchase. In the preceding process, member information of the second e-commerce platform 20 does not need to be disclosed to the first e-commerce platform 10. Please refer to FIG. 1, FIG. 2A and FIG. 2B at the same time for the following description.

Step S11: Provide the first e-commerce platform 10, the second e-commerce platform 20, and the transaction management end platform 30. The transaction management end platform 30 is connected to the first e-commerce platform 10 and the second e-commerce platform 20 respectively.

Step S12: Set a first e-commerce product information 15 and a first e-commerce platform information 19 in the first e-commerce platform 10; set a second e-commerce product information 25 and a second e-commerce platform information 29 in the second e-commerce platform 20. In this embodiment, first e-commerce product information 15 includes ten hair products and twenty body care products. Each hair product is priced at 450 NT dollars and each body care product is priced at 550 NT dollars. The industry classifications of both the hair products and the body care products are classified as category of cosmetics or beauty care. The second e-commerce product information 25 includes twenty hair products, thirty body care products, and forty biscuit products. Each hair product is priced at 650 NT dollars, each beauty product is priced at 550 NT dollars, and each biscuit product is priced 350 NT dollars, the industry classification of both the hair products and body care products are classified as category of cosmetics or beauty care, and the industry classification of biscuit products is classified as the food category. The first e-commerce platform information 19 keeps a record of the industry classification of the first e-commerce platform 10 comprising category of cosmetics or beauty care, and the number of consumers of first e-commerce platform10 which is 1,000 people. The second e-commerce platform information 29 keeps a record of the industry classification of the second e-commerce platform 20 comprising category of cosmetics or beauty care as well as the food category, and the number of members of the second e-commerce platform 20 which is 2000 people.

Step S13: Set the first product transceiver module 11 in the first e-commerce platform 10, the second product transceiver module 21 in the second e-commerce platform 20, and the management end product transceiver module 31 in the transaction management end platform 30.

Step S14: Set the first e-commerce member information 16 in the first e-commerce platform 10, the second e-commerce member information 26 in the second e-commerce platform 20 The first e-commerce member information 16 corresponds to the first e-commerce member and the second e-commerce member information 26 corresponds to the second e-commerce member. The first e-commerce member information 16 is independent of the second e-commerce member information 26, and the first e-commerce member informationl6 is only stored in the first e-commerce platform 10, the second e-commerce member information 26 is only stored in the second e-commerce platform 20.

Step S15: Set the first communication register module 12 in the first e-commerce platform 10, the second communication register module 22 in the second e-commerce platform 20, and the management end communication register module 32 in the transaction management end platform 30.

Step S16: A communication link is established between the first e-commerce platform 10 and the second e-commerce platform 20 to discuss the listing matter of each other's products. The path of the communication link is through the first communication register module 12, the management end communication register module 32, and the second communication register module 22. When the e-commerce vendors of the first e-commerce platform 10 and the e-commerce vendors of the second e-commerce platform 20 need to communicate and discuss in advance for the matter concerning each other's products to be put on the shelves, the discussion can be conducted via this communication link.

Step S17: At least the management end communication register module 32 records and stores the communication content of the communication link. This step is to provide one of the monitoring mechanisms to enhance the mutual trust between e-commerce vendors. Furthermore, it is also used to record the communication content between the first e-commerce platform 10 and the second e-commerce platform 20 when there is a dispute about the transaction, which achieves the effect of evidence perpetuation.

Step S18: The first product transceiver module 11 sends the first e-commerce product information 15 and the first product listing rule 14 to the management end product transceiver module 31. The management end product transceiver module 31 determines whether the first e-commerce product information 15 is allowed to be sent to the second product transceiver module 21 via the transaction management end platform 30 according to the management end product listing rule 34 and the first product listing rule 14. If it is allowed, proceed to the next step; if it is not allowed, the process of this method is ended. It is shown in FIG. 1 that the first product listing rule 14 is to set the conditions for the first e-commerce product information 15, the second e-commerce platform 20, or the second e-commerce product information 25 to meet. Only when the abovementioned conditions are met, the first e-commerce product information 15 is allowed to be sent to the second e-commerce platform 20 through the transaction management end platform 30. For example, one may set the minimum order amount of the products in the first e-commerce product information 15 to accept orders, or the e-commerce company still may control the pricing rights of their own product prices by setting the minimum sales price of the products on the second e-commerce platform 20 to avoid price cut competition. Otherwise, one may set the condition that the industry classification, the number of products, or the product prices must be the same or similar (for example, within 20% of the difference) between the first e-commerce product information 15 and the second e-commerce product information 25. Alternatively, the industry classification and the number of members must be the same or similar (for example, within 20% of the difference) between the first e-commerce platform 10 and the second e-commerce platform 20. However, it should be understood that the present invention is not limited to the above conditions. The management end product listing rule 34 sets the conditions that the first e-commerce product information 15 must meet to control the quality of the products corresponding to the first e-commerce product information 15 for ensuring the product quality and safety. The management end product listing rule 34 includes but is not limited to: a product regulation, a product quality information, or a combination thereof. The management end product transceiver module 31 can pre-store first e-commerce product information 15, first e-commerce platform information 19, second e-commerce product information 25, second e-commerce platform information 29, or update the above information depending on the requirement to help the management end product transceiver module 31 for determining action to carry out.

Step S19: After the second product transceiver module 21 receives the first e-commerce product information 15, the second product transceiver module 21 determines whether the first e-commerce product information 15 is allowed to be launched according to the second product listing rule 24. If the previous step is allowed, proceed to the next step; if it is not allowed, then the process of this method ends. The second product listing rule 24 is used to set conditions, such as setting the required conditions for the first e-commerce the product information 15, the first e-commerce platform 10 or the second e-commerce product information 25 to meet. Once the preceding conditions are met, the first e-commerce product information 15 is allowed to be received by the second e-commerce platform 20. The conditions that can be set in the second product listing rule 24 include: industry classification of the first e-commerce product information 15, number of products from the first e-commerce product information 15, product prices of the first e-commerce product information 15, an industry classification of the first e-commerce platform 10, number of members of the first e-commerce platform 10, an industry classification of the second e-commerce product information 25, number of products of the second e-commerce product information 25, product prices of the second e-commerce product information 25, or the combination thereof. The scope of the present invention is not limited to the present embodiment. For the application of the second product listing rule 24, please refer to the description of the first product listing rule 14 that is mentioned previously.

Step S20: The second e-commerce platform 20 lists the first e-commerce product information 15 so that the second e-commerce platform 20 can sell the products corresponding to the first e-commerce product information 15 and the products corresponding to the second e-commerce product information 25 at the same time.

Step S21: The second product transceiver module 21 combines one of the first e-commerce product information 15 and one of the second e-commerce product information 25 according to the second product portfolio rule 28 into an e-commerce product portfolio, so that the e-commerce product portfolio can be listed on the second e-commerce platform 20. The conditions of the second product portfolio rule 28 can include but are not limited to: an industry classification of the first e-commerce product information 15, number of products of the first e-commerce product information 15, product prices of the first e-commerce product information 15, an industry classification of the first e-commerce platform10, a number of members of the first e-commerce platform 10, an industry classification of the second e-commerce platform 20, number of members of the second e-commerce platform 20, an industry classification of the second e-commerce product information 25, a number of products of the second e-commerce product information 25, product prices of the second e-commerce product information 25, or a combination thereof. For example, if there are 10 products A from the first e-commerce platform 10 and 12 products B from the second e-commerce platform 20, then these two kinds of products (i.e., product A and product B respectively) with similar number of products can be combined and sold together (In other words, one product A and one product B are formed into one group in the present embodiment, ending up 10 groups presented thereafter). On the other hand, combine the existing products having the same or related industry classification (for example, both products are hair products) which are sold exclusively on both the first e-commerce platform 10 and the second e-commerce platform 20 into a product portfolio for sale. Alternatively, combine products with product prices lower than a certain price or higher than a certain price in the first e-commerce product information 15 with the products in the second e-commerce product information 25 into a product portfolio for sale. Otherwise, set a price ceiling first, and then combine the products of the first e-commerce product information 15 and the second e-commerce product information 25 to sell together (e.g., the combined selling price of two products is less than 1,000 NT dollars). It should be noted that the combination of the present invention is not limited to the above embodiment.

Step S22: Set the first social media module 17 in the first e-commerce platform 10 and the second social media module 27 in the second e-commerce platform 20, second e-commerce platform 20 sends the first e-commerce product information 15 or the second e-commerce product information 25 via the second social media module 27 to the second e-commerce member.

Step S23: Set the first product transaction module 13 in the first e-commerce platform 10, the second product transaction module 23 in the second e-commerce platform 20, and the management end product transaction module 33 in the transaction management end platform 30.

Step S24: The second product transaction module 23 generates an order information 40 in response to the booking of the products from the second e-commerce member corresponding to the first e-commerce product information 15 and sends the order information 40 to the management end product transaction module 33, where the abovementioned order information does not include the second e-commerce member information 26.

Step S25: The management end product transaction module determines whether it is allowed to send the order information to the first product transaction module 13 according to the management end product transaction rule. If the conditions are allowed, proceed to the next step; if the conditions are not allowed, end the present method. In this step, the management end product transaction module 33 of the transaction management end platform 30 receives the order information 40 from the second product transaction module 23. In this regard, the transaction management end platform 30 will not contact any second e-commerce members, and the order information 40 does not include the second e-commerce member information 26, so that the second e-commerce member information 26 has not been exposed, and the security of second e-commerce member information 26 is also guaranteed. The conditions that can be set by the management end product transaction rule 35 include but are not limited to: cap amount for order, of the first e-commerce platform 10, cap amount for order of the second e-commerce platform 20, or a combination thereof. The cap amount for order of the first e-commerce platform 10 and the cap amount for order of the second e-commerce platform20 can be pre-set by the transaction management end platform 30 based on the conditions including the business scale and the company's financial status of the first e-commerce platform 10 and the second e-commerce platform 20. The conditions are set in advance so that the first e-commerce platform 10 and the second e-commerce platform 20 can conduct transactions of a reasonable amount, ensuring the security of cash flow. The scope of the present invention does not limit the setting method and setting conditions provided by the management end product transaction rule 35. In addition, the present invention does not limit that when it is determined that the order information 40 is allowed to be sent to the first product transaction module 13, the management end product transaction module 33 either directly transmits the order information 40 to the first product transaction module 13 or further edits the content of the order information 40 which is then be sent to first product transaction module 13 based on commercial considerations.

Step S26: The first product transaction module 13 delivers the product corresponding to the first e-commerce product information 15 ordered by the second e-commerce member to the designated locations, where the designated locations are not related to the second e-commerce member information 26. In the present step, the first product transaction module 13 of the first e-commerce platform 10 receives the order information 40 sent from the management end product transaction module 33, so the first product transaction module 13 will not contact any second e-commerce member, nor will it receive any second e-commerce member information 26, thereby avoiding the outflow of the second e-commerce member information 26, and once again guaranteeing the security of the second e-commerce member information 26. When the products corresponding to the first e-commerce product information 15 are delivered to the designated location, the second e-commerce platform 20 will send it from the designated location to the second e-commerce member who purchased it by any kind of logistics transportation method. The designated location can be determined by a prior agreement between the first e-commerce platform 10 and the second e-commerce platform 20, or can be designated by the second e-commerce platform 20, or designated in other ways, thereby ensuring the safety of logistics.

Step S27: When a member of the second e-commerce platform20 (not shown in figures) requires the customer service after purchasing the products from the first e-commerce platform 10, a communication link will first be established between the abovementioned member and the second communication register module 22 of the second e-commerce platform 20, and then the path thereof extends by connecting the management end communication register module 32 and the first communication register module 12 to the first e-commerce vendor 111 of the first e-commerce platform 10 for establishing a new communication link. Thereby, members of the second e-commerce platform 20 can acquire the after-sales customer service provided by the first e-commerce vendor 111 of the first e-commerce platform 10. The present invention establishes a virtual customer service center through the above steps, so that the members who purchase the products consider that they have talked with the customer service personnel of the e-commerce platform to which they belong. However, the communication link is actually connected to the customer service personnel of the e-commerce platform that actually sold the product as the intermediary service of the transaction management end platform 30 in order to obtain the after-sales customer service. For the first e-commerce vendor 111 of the first e-commerce platform10, it only establishes a communication link to communicate with a member, and thus does not directly obtain the information of that member of the second e-commerce platform 20. The first e-commerce vendor 111 and the second e-commerce vendor 222 can also sign a contract in advance, stipulating that each other shall not disclose specific information when providing after-sales customer services and shall not obtain the information of each other's members. In addition, the management end communication register module 32 can still record and store the communication content of the communication link to achieve the effect of evidence perpetuation.

In summary, the method for secure transactions between multiple e-commerce vendors proposed in the present invention can make it possible for e-commerce vendors to trade each other's products without revealing their own member information to other e-commerce vendors. The secure transaction method of the present invention allows e-commerce vendors of the first e-commerce platform 10 to promote their products to members of the second e-commerce platform 20 for purchase, and likewise the e-commerce vendors of the second e-commerce platform 20 can also easily find new products to launch for its members to purchase, and there is no concerning about the information of its members being exposed to e-commerce vendors on the first e-commerce platform 10. In addition, for members of the second e-commerce platform 20, there is no need to register and search for products on other e-commerce platforms to purchase new products.

It should be noted that the steps in FIG. 2A and FIG. 2B can be modified according to the requirements of the e-commerce vendors. For example, in one embodiment, the e-commerce vendors of the first e-commerce platform 10 expect to promote the first e-commerce product information 15 on the second e-commerce platform 20 for being available as much as possible. Accordingly, the condition of the first product listing rule 14 is not required to be set. Likewise, in another embodiment, the e-commerce vendors of the second e-commerce platform 20 wants to make the first e-commerce product information 15 be available on the second e-commerce platform 20 as much as possible, so that the second product listing rule 24 is no more required to be set. Alternatively, in the other embodiment, the transaction management vendor 333 of the transaction management end platform 30 would like to make the first e-commerce product information 15 be available on the second e-commerce platform 20 as much as possible. Therefore, there is no requirement to set the conditions of the management end product listing rule 34 anymore. In addition, if the vendors of the first e-commerce platform 10 or the second e-commerce platform 20 do not have a requirement to combine the first e-commerce product information 15 with the second e-commerce product information 25, the first product portfolio rule 18 or the second product portfolio rule 28 may not be set.

In the embodiment shown in FIG. 2A and FIG. 2B, the first e-commerce product information 15 is sent to the second product transceiver module 21 by the management end product transceiver module 31 after determining that the conditions set with the management end product listing rule 34 and the first product listing rule 14 are met. However, in other embodiments of the present invention, the first product listing rule 14 and the first e-commerce product information 15 can be pre-sent from the first product transceiver module 11 to the transaction management end platform 30 for storage, until the vendor of the second e-commerce platform 20 feels like to launch the first e-commerce product information 15 on the first e-commerce platform and thus the second product transceiver module 21 sends the request to the management end product transceiver module 31. Then, the management end product transceiver module 31 will determine whether it is allowed to send the first e-commerce product information 15 from the transaction management end platform 30 to the second product transceiver module 21 based on the management end product listing rule 34 and the first product listing rule 14.

In addition to the e-commerce platform system 1 shown in FIG. 1, it should be understood that other embodiments of the present invention may include a plurality of different e-commerce platforms at the same time, and each e-commerce platform has its own e-commerce product information. Each e-commerce platform vendor can set product listing rules to require that only when certain conditions are met that the e-commerce product information was listed to other e-commerce platforms. E-commerce platforms allowed to receive or list other people's e-commerce product information can also set their preferred product listing rules. When the received e-commerce product information from others meets the conditions, they will be listed on their own e-commerce platform for promotion to members of their own e-commerce platform. In the previous process, the transaction management end platform can also ensure the quality of the products corresponding to each e-commerce product information according to the conditions of the management end product listing rule. It should further be understood that, in another embodiment with a plurality of different e-commerce platforms, the vendors of each e-commerce platform may first send their e-commerce product information and product listing rules to the transaction management end platform for storage. Once the vendor with an e-commerce platform requires to list other e-commerce product information, the e-commerce platform of the specific vendor sends a request to the transaction management end platform. Then, the management end product transceiver module of the transaction management end platform determines which e-commerce product information can be sent to the e-commerce platform of the vendor according to the management end product listing rule, each e-commerce product information and the product listing rules corresponding to said e-commerce product information.

As is understood by a person skilled in the art, the foregoing preferred than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A method for secure transactions among e-commerce vendors allowing each e-commerce vendor to trade products with one another without disclosing member information, which comprising the steps:
(A) providing a first e-commerce platform, a second e-commerce platform, a transaction management end platform, wherein the transaction management end platform is connected to the first e-commerce platform and the second e-commerce platform respectively;
(B) setting a first e-commerce product information and a first e-commerce platform information in the first e-commerce platform; setting a second e-commerce product information and a second e-commerce platform information in the second e-commerce platform;
(C) setting a first product transceiver module in the first e-commerce platform, a second product transceiver module in the second e-commerce platform, and a management end product transceiver module in the transaction management end platform;
(D) the first product transceiver module sending the first e-commerce product information to the management end product transceiver module, wherein the management end product transceiver module determines whether to send the first e-commerce product information to the second product transceiver module according to a management end product listing rule, wherein the management end product listing rule sets a condition that the first e-commerce product information must meet; if the first e-commerce product information is permitted to be sent to the second product transceiver module, taking step (E); and
(E) upon the second product transceiver module receiving the first e-commerce product information, listing the first e-commerce product information to concurrently sell products corresponding to the first e-commerce product information and the second e-commerce product information.

2. The method for secure transactions among e-commerce vendors as claimed in claim 1, wherein the management end product listing rule comprises a product regulation, a product quality information, or a combination thereof.

3. The method for secure transactions among e-commerce vendors as claimed in claim 1, wherein the step (D) further comprises:
(D1) the first product transceiver module sending a first product listing rule to the management end product transceiver module, wherein the first product listing rule sets conditions for the first e-commerce product information, the second e-commerce platform or the second e-commerce product information; and
(D2) the management end product transceiver module determining whether allowing the first e-commerce product information be sent to the second product transceiver module according to the management end product listing rule and the first product listing rule, if the sending of the first e-commerce product information to the second product transceiver module is permitted, taking step (E).

4. The method for secure transactions among e-commerce vendors as claimed in claim 3, wherein the first product listing rule further comprises:
an industry classification of the first e-commerce product information, a number of products of the first e-commerce product information, product prices of the first e-commerce product information, an industry classification of the second e-commerce platform, a number of members of the second e-commerce platform, an industry classification of the second e-commerce product information, a number of products of the second e-commerce product information, product prices of the second e-commerce product information or a combination thereof.

5. The method for secure transactions among e-commerce vendors as claimed in claim 1, wherein the step (E) further comprises:
(E1) upon the second product transceiver module receiving the first e-commerce product information, determining whether to list the first e-commerce product information according to a second product listing rule, wherein the second product listing rule sets the conditions for the first e-commerce platform, the first e-commerce product information or the second e-commerce product information, if listing the first e-commerce product information is permitted, then taking step (E2); and
(E2) the second e-commerce platform listing the first e-commerce product information therefore to concurrently sell the products corresponding to the first e-commerce product information and the second e-commerce product information.

6. The method for secure transactions among e-commerce vendors as claimed in claim 5, wherein the second product listing rule further comprises:
an industry classification of the first e-commerce product information, a number of products of the first e-commerce product information, product prices of the first e-commerce product information, an industry classification of the first e-commerce platform, a number of members of the first e-commerce platform, an industry classification of the second e-commerce product information, a number of products of the second e-commerce product information, product prices of the second e-commerce product information or a combination thereof.

7. The method for secure transactions among e-commerce vendors as claimed in claim 1, wherein the step (E) further comprises:
(E1) upon the second product transceiver module receiving the first e-commerce product information, one of the first e-commerce product information and one of the second e-commerce product information are assembled into an e-commerce product portfolio by the second product transceiver module according to a second product portfolio rule; and
(E2) the second e-commerce platform listing the e-commerce product portfolio.

8. The method for secure transactions among e-commerce vendors as claimed in claim 7, wherein the second product portfolio rule further comprises:
an industry classification of the first e-commerce product information, a number of products of the first e-commerce product information, product prices of the first e-commerce product information, an industry classification of the first e-commerce platform, a number of members of the first e-commerce platform, an industry classification of the second e-commerce platform, a number of members of the second e-commerce platform, an industry classification of the second e-commerce product information, a number of products of the second e-commerce product information, product prices of the second e-commerce product information or a combination thereof.

9. The method for secure transactions among e-commerce vendors as claimed in claim 1, wherein the steps further comprise:
(F1) setting a first communication register module in the first e-commerce platform, a second communication register module in the second e-commerce platform, and a management end communication register module in the transaction management end platform;
(F2) establishing a communication link between the first e-commerce platform and the second e-commerce platform for discussing listing of products, wherein the communication link connects the first communication register module, the management end communication register module and the second communication register module; and
(F3) recording and storing communications via the communication link by at least the management end communication register module.

10. The method for secure transactions among e-commerce vendors as claimed in claim 1, wherein the steps further comprise:
(F) setting a first e-commerce member information in a first e-commerce platform, a second e-commerce member information in a second e-commerce platform, wherein the first e-commerce member information corresponds to first e-commerce member, wherein the second e-commerce product information corresponds to second e-commerce member, wherein the first e-commerce member information is independent of the second e-commerce product information, wherein the first e-commerce member information is solely stored in the first e-commerce platform, wherein the second e-commerce product information is solely stored in the second e-commerce platform.

11. The method for secure transactions among e-commerce vendors as claimed in claim 10, wherein the steps further comprise:
(G) setting a first product transaction module in the first e-commerce platform, a second product transaction module in the second e-commerce platform, and a management end product transaction module in the transaction management end platform;
(H) the second product transaction module producing an order information in response to booking of the products corresponding to the first e-commerce product information from the second e-commerce member, sending the order information to the management end product transaction module, wherein the second e-commerce member information is not included in the order information;
(I) the management end product transaction module sending the order information to the first product transaction module;
(J) the first product transaction module sending the products corresponding to the first e-commerce product information ordered by the second e-commerce member to designated location, wherein the designated locations are not related to the second e-commerce member information.

12. The method for secure transactions among e-commerce vendors as claimed in claim 11, wherein the step (I) further comprises:
(I1) the management end product transaction module determining whether to permit sending the order information to the first product transaction module according to a management end product transaction rule, wherein the management end product transaction rule sets transaction conditions for the first e-commerce platform or the second e-commerce platform, if the transaction conditions are permitted, then taking step (J).

13. The method for secure transactions among e-commerce vendors as claimed in claim 12, wherein the management end product transaction rule comprises:
a cap amount for order of the first e-commerce platform, a cap amount for order of the second e-commerce platform, or a combination thereof.

14. The method for secure transactions among e-commerce vendors as claimed in claim 1, wherein the steps further comprise:
(F) setting a first social media module in the first e-commerce platform and a second social media module in the second e-commerce platform, wherein the first e-commerce member of the first e-commerce platform establishes verbal or multimedia communications with the vendor of the first e-commerce platform via the first social media module, wherein the second e-commerce member of the second e-commerce platform establishes verbal or multimedia communications with the vendor of the second e-commerce platform via the second social media module;
(G) the second e-commerce platform sending the first e-commerce product information or the second e-commerce product information to the second e-commerce member via the second social media module.
